(19) United States
(12) Patent Application Publication
(10) Pub. No.: US 2022/0190568 A1
(43) Pub. Date: Jun. 16, 2022

(54) FLEXIBLE EXTERIOR MEMBER FOR WIRE GUIDE AND WIRE GUIDE DEVICE

(71) Applicant: SUMITOMO WIRING SYSTEMS, LTD., Mie (JP)

(72) Inventors: Kousuke YOSHIDA, Mie (JP); Hiroki UNO, Mie (JP); Hiroshi INOUE, Mie (JP)

(21) Appl. No.: 17/438,332

(22) PCT Filed: Dec. 27, 2019
(86) PCT No.: PCT/JP2019/051403

§ 371 Date: Sep. 10, 2021

(30) Foreign Application Priority Data
Mar. 13, 2019 (JP) 2019-046417

(51) Int. Cl. H02G 3/04; B60R 16/02

(52) U.S. Cl. CPC H02G 3/0475; B60R 16/0215

(57) ABSTRACT

It is aimed to provide a flexible exterior member for wire guide 12 including a hollow tubular portion 34 to be sheathed on a wire guide 10 bendable and deformable into a predetermined shape, a slit 36 provided over an entire length in an axial direction of the tubular portion 34, and a pair of joining portions 48, 48 respectively provided on a pair of circumferential end surfaces 50, 50 of the tubular portion 34 divided by the slit 36, the pair of joining portions 48, 48 being put together and joined to each other, and a wire guide device G using this flexible exterior member for wire guide 12.

### TECHNICAL FIELD

The present disclosure relates to a flexible exterior member for wire guide and a wire guide device.

### BACKGROUND

Patent Document 1 discloses a wire guide device used by being sheathed on a wiring harness laid between a body of an automotive vehicle and a movable body such as a slide door. The wire guide device includes a wire guide formed by successively coupling a plurality of link frame bodies rotatably relative to each other, and a rubber boot serving as a flexible exterior member to be sheathed on the wire guide for dustproofing and waterproofing of the wire guide. The wire guide and the rubber boot protect the wiring harness laid between the body and the movable body and allow the wiring harness to be curved when the movable body moves with respect to the body.

### PRIOR ART DOCUMENT

### Patent Document

### SUMMARY OF THE INVENTION

### Problems to be Solved

The rubber boot is in the form of a hollow rectangular tube and formed to be long. To sheathe the rubber boot on the wire guide, the wire guide inserted through one opening end in a length direction of the rubber boot needs to be pulled out from the other opening end in the length direction of the rubber boot. Thus, an operation of inserting the wire guide into the rubber boot is difficult and takes time. Therefore, measures for facilitating this inserting operation are desired.

Against this, it is considered to improve insertion workability by increasing the size of the rubber boot to increase a clearance between facing surfaces of the wire guide and the rubber boot. However, cost increases and the dustproofness and waterproofness of the rubber boot are deteriorated due to the enlargement of the rubber boot. Thus, this measure cannot be said to be preferable. Further, it is also considered to improve workability by applying a lubricant between the rubber boot and the wire guide. However, a separate operation of applying the lubricant is necessary, causing a cumbersome manufacturing process. Thus, this cannot be said to be an effective measure.

Accordingly, it is aimed to provide a novel flexible exterior member for wire guide which can be easily sheathed on a wire guide and a novel wire guide device using this flexible exterior member for wire guide.

### Means to Solve the Problem

The present disclosure is directed to a flexible exterior member for wire guide with a hollow tubular portion to be sheathed on a wire guide bendable and deformable into a predetermined shape, a slit provided over an entire length in an axial direction of the tubular portion, and a pair of joining portions respectively provided on a pair of circumferential end surfaces of the tubular portion divided by the slit, the pair of joining portions being put together and joined to each other.

The present disclosure is also directed to a wire guide device with a wire guide bendable and deformable into a predetermined shape, and the flexible exterior member for wire guide sheathed on the wire guide.

### Effect of the Invention

According to the present disclosure, it is possible to provide a novel flexible exterior member for wire guide which can be sheathed on a wire guide and a novel wire guide device using this flexible exterior member for wire guide.

### BRIEF DESCRIPTION OF THE DRAWINGS

FIG. 1 is a schematic diagram showing a state where a wire guide device according to one embodiment is mounted in a vehicle.

FIG. 2 is a plan view of a link frame body shown in FIG. 1.

FIG. 3 is a section along III-III in FIG. 2.

FIG. 4 is a perspective view of a flexible exterior member for wire guide shown in FIG. 1.

FIG. 5 is a front view showing a method for sheathing the flexible exterior member for wire guide shown in FIG. 4 on a wire guide.

FIG. 6 is a front view showing a state of one axial end part of the wire guide device shown in FIG. 1 when the wire guide device is mounted in the vehicle.

FIG. 7 is a section along VII-VII in FIG. 6.

FIG. 8 is a front view, corresponding to FIG. 6, showing a wire guide device according to a second modification.

### DETAILED DESCRIPTION TO EXECUTE THE INVENTION

### Description of Embodiments of Present Disclosure

First, embodiments of the present disclosure are listed and described.

(1) The flexible exterior member for wire guide of the present disclosure includes a hollow tubular portion to be sheathed on a wire guide bendable and deformable into a predetermined shape, a slit provided over an entire length in an axial direction of the tubular portion, and a pair of joining portions respectively provided on a pair of circumferential end surfaces of the tubular portion divided by the slit, the pair of joining portions being put together and joined to each other.

According to the flexible exterior member for wire guide of the present disclosure, the tubular portion to be sheathed on the wire guide bendable and deformable into the predetermined shape is provided with the slit extending over the entire length in the axial direction. In this way, when the tubular portion of the flexible exterior member is sheathed on the wire guide, an opening continuous over the entire axial length of the tubular portion can be provided by opening the slit of the tubular portion. As a result, the wire guide can be easily and quickly accommodated into the tubular portion through the slit of the tubular portion. Therefore, a rubber boot can be easily sheathed on the wire guide as compared to the case where the wire guide inserted into a tubular portion of the rubber boot from one axial opening end is pulled out from the other axial opening end of the tubular portion as in the conventional structure.

In this way, the flexible exterior member can be sheathed on the wire guide after a wiring harness is inserted into the wire guide, and it becomes possible to automate an assembling operation. Further, in the conventional structure, terminals provided on the tip of the wiring harness enclosed in the wire guide may be deformed by an inserting operation when the rubber boot is sheathed on the wire guide. However, the flexible exterior member for wire guide of the present disclosure can also avoid possible deformation of the terminals. Further, the necessity of a separate operation for facilitating the insertion of the flexible exterior member into the wire guide such as the application of a lubricant can also be reduced or eliminated.

Moreover, the pair of joining portions are respectively provided on the pair of circumferential end surfaces of the tubular portion divided by the slit and the joining portions are put together and joined to each other. Thus, after the flexible exterior member is sheathed on the wire guide, the opening formed by the slit of the tubular portion can be closed by joining the pair of joining portions. In this way, the detachment of the flexible exterior member from the wire guide can be hindered and the dustproofness and waterproofness of the flexible exterior member can be advantageously ensured. Particularly, by providing the tubular portion with the slit, the flexible exterior member can be easily sheathed on the wire guide without requiring the enlargement of the tubular portion. Therefore, a clearance between facing surfaces of the flexible exterior member and the wire guide can be made as small as possible and the dustproofness and waterproofness of the flexible exterior member can be further improved.

In addition, since the pair of joining portions are put together and doubled, the strength of the pair of joining portions and a joined part where a stress easily concentrates when the wire guide is deformed can be advantageously ensured. Note that an arbitrary joining method can be adopted as a method for joining the pair of joining portions to each other and a known method such as mechanical joining, welding or adhesion is possibly adopted.

(2) Preferably, the pair of joining portions are continuously provided over the entire length in the axial direction of the tubular portion. This is because the opening formed by the slit can be more stably closed by putting and joining the pair of joining portions, which are continuously provided over the entire length in the axial direction of the tubular portion, to each other. In this way, the dustproofness and waterproofness of the flexible exterior member can be more stably ensured.

(3) Preferably, the pair of joining portions respectively project outward in a right angle direction to an axis of the tubular portion from the pair of circumferential end surfaces of the tubular portion. Since the pair of joining portions project outward in the right angle direction to the axis of the tubular portion, a clearance between facing surfaces of the tubular portion and the wire guide can be advantageously made small and the dustproofness and waterproofness of the flexible exterior member can be more stably ensured. Further, since the pair of joining portions project outward in the right angle direction to the axis of the tubular portion from the pair of circumferential end surfaces of the tubular portion, a space necessary for a joining operation of the pair of joining portions is easily secured and workability can be improved. For example, in the case of joining the pair of joining portions by thermal welding or ultrasonic welding, a space for arranging an instrument such as a hot sealer or ultrasonic horn can be easily secured.

(4) Preferably, the tubular portion is in the form of a rectangular tube and the pair of joining portions are provided on a surface located on a lower side when the flexible exterior member is mounted in a vehicle, out of four surfaces of the tubular portion. This is because the pair of joining portions can be made difficult to see from a user and an appearance can be improved by providing the pair of joining portions projecting outwardly of the tubular portion on the lower surface when the flexible exterior member is mounted in the vehicle. Further, the rigidity and strength of the flexible exterior member are improved in the joined part where the pair of joining portions are put together and doubled. Therefore, by providing the pair of joining portions on the lower side when the flexible exterior member is mounted in the vehicle, the pair of joining portions can exhibit an effect of preventing downward slack of intermediate parts in the length direction of the wiring harness and the wire guide, such as when the wiring harness is a long one laid between a body and a slide door of an automotive vehicle.

(5) Preferably, the pair of joining portions are in the form of flat plates having smooth surfaces. This is because a clearance is hardly formed between the joining portions and more strong joining can be realized when the pair of joining portions are put together and joined.

(6) Preferably, the pair of joining portions are provided to be arranged on a line connecting a plurality of bend center points of the wire guide. This is because a strain applied to the joined part of the pair of joining portions can be suppressed to a minimum level and the peeling of the joining portions can be advantageously prevented when the wire guide is bent and deformed.

(7) Preferably, the tubular portion includes a bellows-like portion formed by alternately connecting large-diameter portions and small-diameter portions in the axial direction. Since the bellows-like portion has a wavy longitudinal cross-sectional shape by alternately connecting the large-diameter portions and the small-diameter portions in the axial direction of the tubular portion, the bellows-like portion can expand and contract in the axial length direction and smoothly follow the wire guide in a bending direction. Thus, the tubular portion is hardly strained even if the wire guide is repeatedly bent and deformed, and the durability of the tubular portion can be advantageously improved.

(8) Preferably, the flexible exterior member for wire guide of the present disclosure is formed using a thermoplastic elastomer and the pair of joining portions are joined by being welded to each other. By making the flexible exterior member for wire guide of thermoplastic elastomer, the flexible exterior member can be formed to be thinner as compared to conventional flexible exterior members made of rubber and a request for size reduction can be met. Further, the pair of joining portions can be joined by welding and a degree of freedom in selecting the joining method can be improved.

(9) The wire guide device of the present disclosure includes a wire guide bendable and deformable into a predetermined shape, and the flexible exterior member for wire guide of at least one of (1) to (8) described above sheathed on the wire guide.

According to the wire guide device of the present disclosure, since the flexible exterior member for wire guide of the present disclosure is sheathed on the wire guide, a device for wire guide facilitating the sheathing of the flexible exterior member on the wire guide can be provided. Further, since the flexible exterior member for wire guide has the configuration of at least any one of (1) to (8) described above, it is possible to provide an excellent wire guide device utilizing the aforementioned functions and effects of the flexible exterior member of the present disclosure.

### DETAILS OF EMBODIMENTS OF PRESENT DISCLOSURE

Specific examples of a flexible exterior member for wire guide and a wire guide device of the present disclosure are described below with reference to the drawings. Note that the present disclosure is not limited to these illustrations and is intended to be represented by claims and include all changes in the scope of claims and in the meaning and scope of equivalents.

### Embodiment

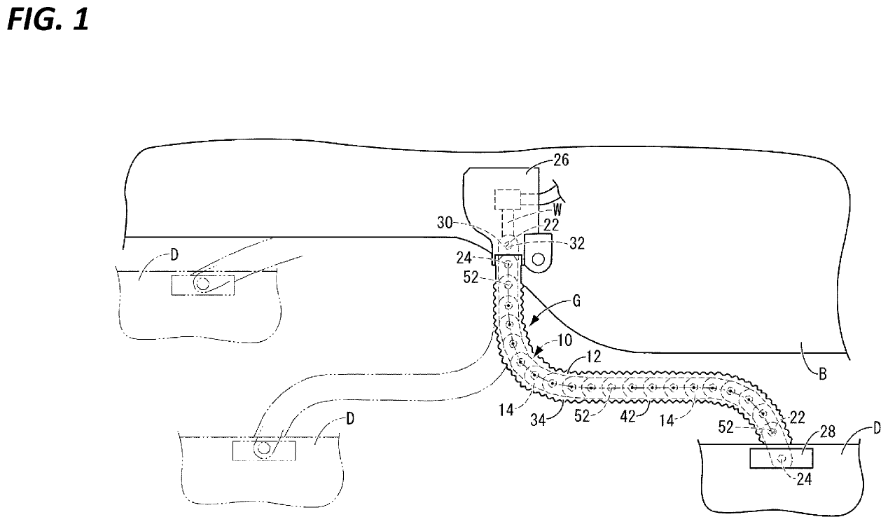

Hereinafter, one embodiment of the present disclosure is described in detail with reference to FIGS. 1 to 7. A wire guide device G of this embodiment is laid between a body B and a slide door D of an automotive vehicle as shown in FIG. 1. The wire guide device G includes a wire guide 10 bendable and deformable into a predetermined shape and a flexible exterior member for wire guide (hereinafter, merely referred to as the flexible exterior member 12) sheathed to protect the wire guide 10. A wiring harness W including one or more wires for supplying power to an electric component and the like equipped in the slide door D is inserted through the wire guide 10.

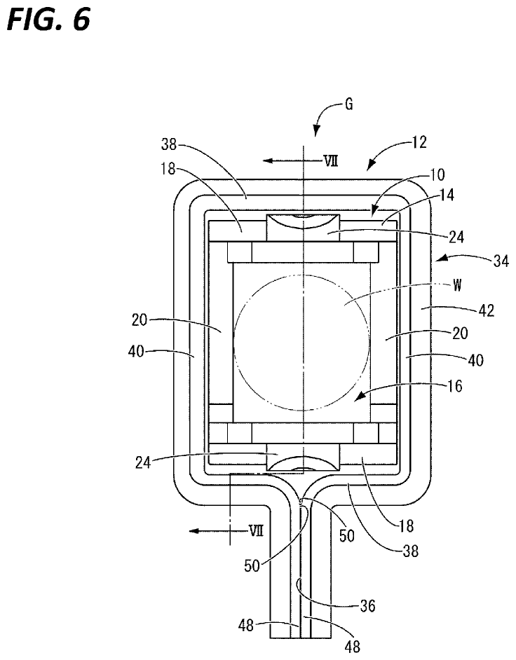

As shown in FIG. 1, the wire guide 10 includes a plurality of link frame bodies 14 successively coupled in a row to be relatively rotatable. The link frame body 14 is made of synthetic resin and in the form of a tube (rectangular tube) having a rectangular shape long in a vertical direction in a front view with the wire guide 10 mounted in the vehicle as shown in FIG. 6. An internal space of the link frame body 14 serves as an insertion space 16 for inserting the wiring harness W. Note that if the wiring harness W includes a plurality of wires, the plurality of wires are normally bundled into one.

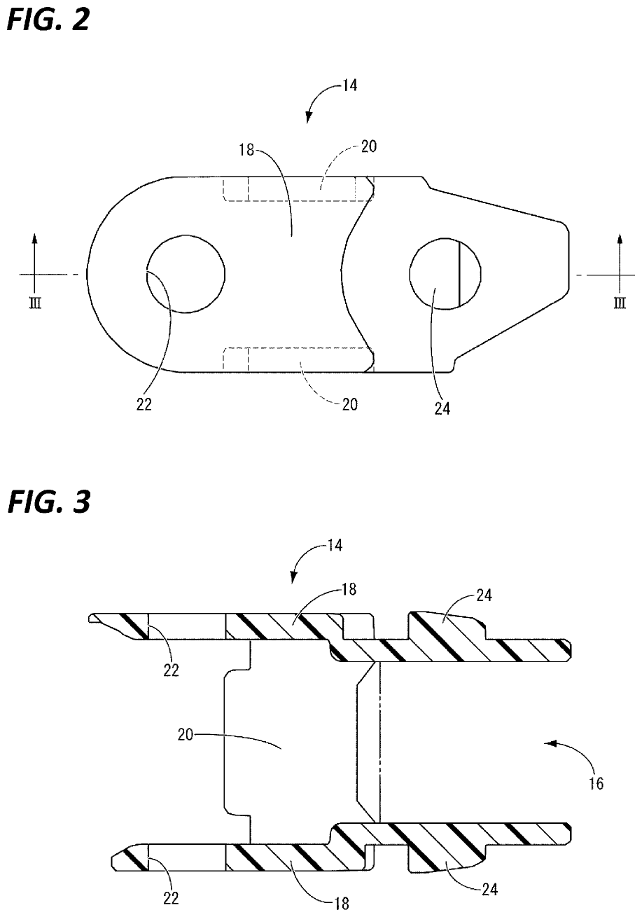

As shown in FIGS. 2, 3 and 5, the link frame body 14 includes a pair of first plate portions 18, 18 and a pair of second plate portions 20, 20 facing each other substantially in parallel. The pair of first plate portions 18 are disposed to face each other in a vertical direction in the state shown in FIG. 6 where the wire guide 10 is mounted in the vehicle.

As shown in FIGS. 2 and 3, coupling holes 22 penetrating through the first plate portions 18 in a plate thickness direction are formed in one end part in a coupling direction of the link frame body 14 and coupling projections 24 projecting on plate surfaces of the first plate portions 18 are provided on the other end part. As shown in FIG. 1, the plurality of link frame bodies 14 arranged in a row are successively coupled by fitting the coupling projections 24 of the other link frame body 14 into the coupling holes 22 of one link frame body 14 adjacent to the other link frame body 14 in an arrangement direction. The adjacent link frame bodies 14 are rotatable relative to each other about center axes 52 of the coupling projections 24. In this way, the wire guide 10 can be bent in an arbitrary direction in parts of the plurality of coupling projections 24 arranged at a predetermined interval in a length direction of the wire guide 10. Therefore, the wire guide 10 is bendable and deformable into a predetermined shape. The plurality of link frame bodies 14 constituting the wire guide 10 have substantially the same shape.

As shown in FIG. 1, both end parts of the wire guide 10 are fixed to a body-side bracket 26 and a door-side bracket 28. A fixing portion 30 to be fixed to the body-side bracket 26 is an end part of the link frame body 14 (end parts of the first plate portions 18 on a side where the coupling holes 22 are formed) disposed closest to the body B, out of the wire guide 10. The fixing portion 30 is accommodated into the body-side bracket 26 and rotatably fixed by fitting locking projections 32 of the body-side bracket 26 into the coupling holes 22.

On the other hand, an end part of the link frame body 14 disposed closest to the slide door D, out of the wire guide 10, is rotatably fixed by fitting the coupling projections 24 into locking holes of the door-side bracket 28. In this way, with the wire guide 10 laid between the body B and the slide door D, the wire guide 10 is so oriented that axial directions of the coupling projections 24 in each link frame body 14 are aligned with the vertical direction (see FIGS. 1 and 6).

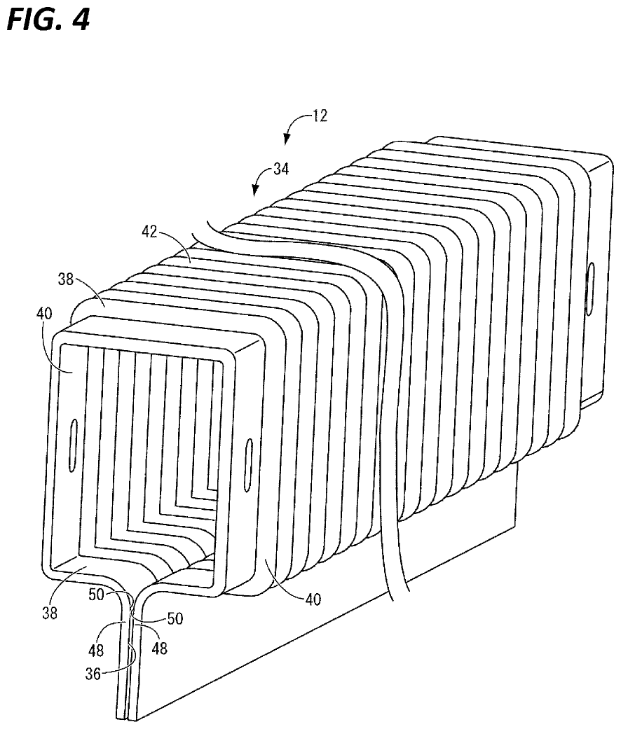

As shown in FIG. 4, the flexible exterior member 12 includes a hollow tubular portion 34 to be sheathed on the wire guide 10 bendable and deformable into a predetermined shape and a slit 36 provided over an entire length in an axial direction of the tubular portion 34. The flexible exterior member 12 can be formed using a flexible synthetic rubber or an elastomer material such as a thermoplastic elastomer. For example, a thermoplastic elastomer such as an olefin-based thermoplastic elastomer (TPO) is adopted in this embodiment and the flexible exterior member 12 can be formed by blow molding. In this way, the tubular portion 34 and a pair of joining portions 48, 48 to be described later of the flexible exterior member 12 can be formed to be thin as compared to the case where the flexible exterior member 12 is formed of synthetic rubber. More specifically, plate thicknesses of the tubular portion 34 and the pair of joining portions 48, 48 to be described later can be set to 1 mm or less, more preferably 0.7 mm or less. In view of durability and the like, it is preferred to adopt a thickness of 0.3 mm or more and 0.6 mm or less. In this embodiment, the thickness of the pair of joining portions 48, 48 is 0.6 mm As a result, the flexible exterior member 12 and the wire guide device G can be reduced in size.

As shown in FIGS. 4 and 6, the tubular portion 34 is in the form of an elongated tube (rectangular tube) as a whole capable of surrounding the wire 10 over an entire length and an entire periphery. The tubular portion 34 has a rectangular shape long in the vertical direction in a front view in conformity with the outer shape of the wire guide 10, and includes a pair of first wall portions 38, 38 extending along the outer surfaces of the first plate portions 18 of the wire guide 10 and a pair of second wall portions 40, 40 extending along the outer surfaces of the second plate portions 20. Here, corner parts coupling the pair of first wall portions 38, 38 and the pair of second wall portions 40, 40 are chamfered. In this way, it is advantageously prevented that the corner parts become excessively thin during the blow molding of the flexible exterior member 12. Note that the slit 36 is provided in one of the pair of first wall portions 38, 38 of the tubular portion 34.

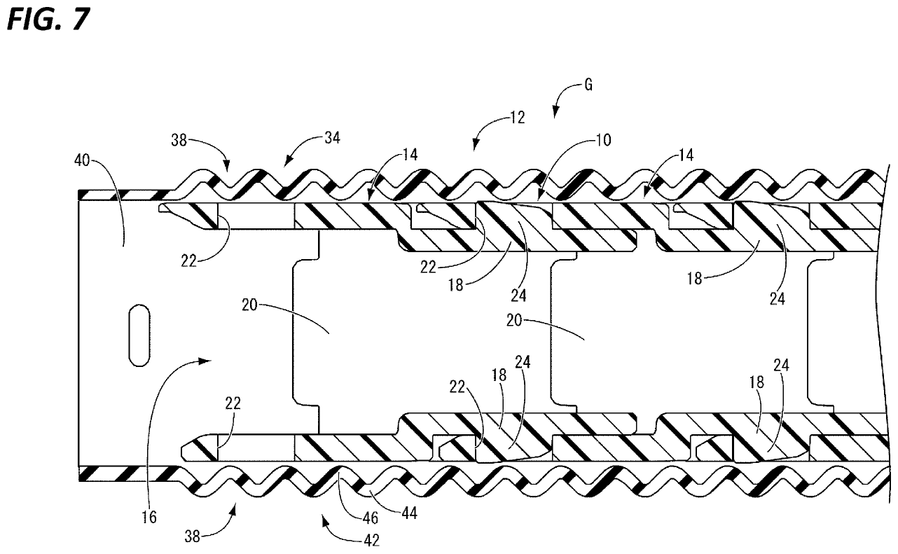

As shown in FIGS. 4 and 7, the tubular portion 34 includes a bellows-like portion 42. The bellows-like portion 42 has a wavy longitudinal cross-sectional shape by alternately connecting large-diameter portions 44 and small-diameter portions 46 in an axial direction as shown in FIG. 7. In this way, the bellows-like portion 42 can expand and contract in a length direction and be bent and deformed in a width direction. Thus, the bellows-like portion 42 can smoothly follow the repeated bending deformation of the wire guide 10, the tubular portion 34 is hardly strained, and the durability of the tubular portion 34 can be advantageously improved. Note that the bellows-like portion 42 is provided on most part of the tubular portion 34 except both end parts in a longitudinal direction of the tubular portion 34. The both end parts (parts where the bellows-like portion 42 is not formed) of the tubular portion 34 are respectively accommodated into the body-side bracket 26 or the door-side bracket 28.

The flexible exterior member 12 further includes the pair of joining portions 48, 48. As shown in FIG. 4, the pair of joining portions 48, 48 are provided to be continuous with a pair of circumferential end surfaces 50, 50 facing each other in a circumferential direction of the tubular portion 34 divided by the slit 36. In this embodiment, the pair of joining portions 48, 48 are in the form of rectangular flat plates projecting outward in a right angle direction to an axis of the tubular portion 34 (downward in FIG. 4) from the pair of circumferential end surfaces 50, 50 and continuously extending over the entire length in the axial direction of the tubular portion 34. As shown in FIG. 4, the pair of joining portions 48, 48 of the flexible exterior member 12 have substantially the same thickness as the first wall portions 38, 38 and the second wall portions 40, 40 of the tubular portion 34. The flexible exterior member 12 is provided as a one-piece article in which the tubular portion 34 and the pair of joining portions 48, 48 are integrally formed.

Since the pair of joining portions 48, 48 in the form of long rectangular flat plates have flat surfaces as shown in FIG. 4, a clearance is hardly formed between the pair of joining portions 48 and 48 and stronger joining can be realized when the pair of joining portions 48, 48 are put together and joined in contact with each other. Further, the pair of joining portions 48, 48 are continuously provided over the entire length in the axial direction of the tubular portion 34. In this way, with the pair of joining portions 48, 48 put together and joined to each other, it can be advantageously realized that the pair of circumferential end surfaces 50, 50 divided by the slit 36 are stably held in a mutual contact state. Further, the dustproofness and waterproofness of the flexible exterior member 12 can be stably ensured.

Next, an example of a manufacturing method of the wire guide device G in this embodiment is described. First, the link frame bodies 14 are coupled to assemble the wire guide 10. Subsequently, the wiring harness W including one or more wires is inserted into the insertion space 16 of the wire guide 10 from one side. The wiring harness W is inserted into the wire guide 10 with the plurality of wires bundled into one. The wiring harness W inserted into the insertion space 16 of the wire guide 10 is drawn out from the other side of the insertion space 16 of the wire guide 10.

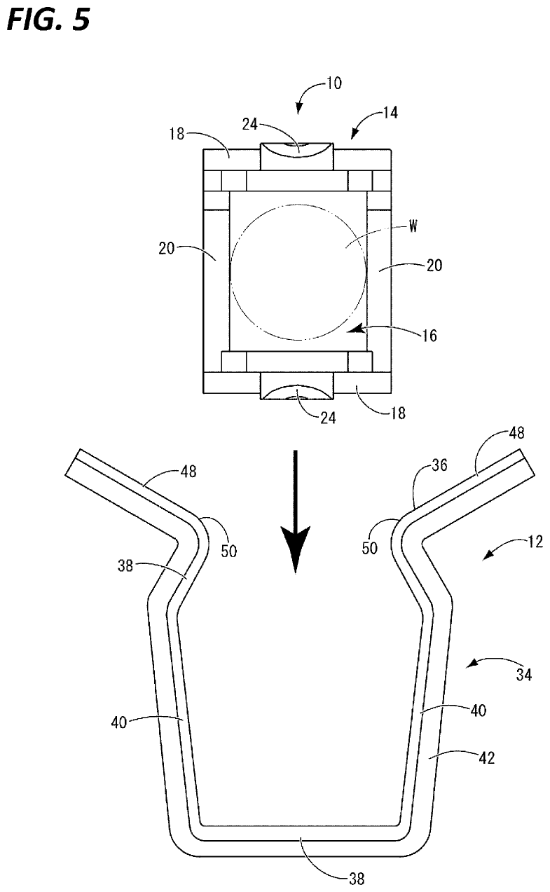

Subsequently, the flexible exterior member 12 is sheathed on the wire guide 10. More specifically, the flexible exterior member 12 is so arranged that the pair of joining portions 48, 48 face upward, for example, as shown in FIG. 5. The slit 36 is sufficiently widened by displacing the pair of joining portions 48, 48 outward in the right angle direction to be separated from each other, and the wire guide 10 is inserted into the flexible exterior member 12 from above. At this time, the wire guide 10 is so oriented that the axial directions of the coupling projections 24 in each link frame body 14 are aligned with the vertical direction. Thereafter, the flexible exterior member 12 is sheathed on the wire guide 10 by returning the pair of joining portions 48, 48 to an initial state where the joining portions 48, 48 are in contact with each other.

In this way, the wire guide 10 is arranged inside the flexible exterior member 12. Subsequently, the pair of joining portions 48, 48 of the flexible exterior member 12 are joined while being put in contact with each other. An arbitrary joining method can be adopted as a joining method. Since the flexible exterior member 12 is formed using the thermoplastic elastomer in this embodiment, joining by welding can be advantageously adopted. More specifically, the pair of joining portions 48, 48 can be thermally welded by being sandwiched, for example, by heated seal bars of a hot sealer. Alternatively, the pair of joining portions 48, 48 are instantaneously ultrasonically welded by applying minute ultrasonic vibration and a pressing force using an ultrasonic welding horn. In the above way, the manufacturing of the wire guide device G is completed. Here, the pair of joining portions 48, 48 are provided to project outward in the right angle direction to the axis of the tubular portion 34 from the pair of circumferential end surfaces 50, 50 of the tubular portion 34. Therefore, a space necessary for a joining operation of the pair of joining portions 48, 48, specifically, a space for arranging an instrument such as a heat sealer or horn, is easily secured and workability can be improved and a degree of freedom in selecting the joining method can be improved.

As shown in FIG. 6, the wire guide device G is laid and routed between the body B and the slide door D in such a state that the pair of joining portions 48, 48 of the flexible exterior member 12 are located on a lower side when the wire guide device G is mounted in the vehicle. That is, the pair of joining portions 48, 48 are provided on the outer surfaces of the first wall portions 38 located on the lower side when the wire guide device G is mounted in the vehicle, out of the outer surfaces of the pair of the first wall portions 38, 38 and the outer surfaces of the pair of second wall portions 40, 40 of the flexible exterior member 12. In this way, the pair of joining portions 48, 48 projecting in the right angle direction to the axis of the tubular portion 34 can be made difficult to see from a user of the automotive vehicle and the appearance of the wire guide device G can be improved. Further, since the pair of joining portions 48, 48 are put together and doubled, a part of the flexible exterior member 12 where the pair of joining portions 48, 48 are provided is formed to be thicker than other parts and has improved rigidity and strength. Therefore, if the wire guide device G laid between the body B and the slide door D is long as in this embodiment, the pair of joining portions 48, 48 put to each other and welded can exhibit an effect of preventing downward slack of an intermediate part in the length direction of the wire guide device G.

As shown in FIG. 1, the pair of joining portions 48, 48 put together and joined to each other are provided to be arranged on a line connecting the center axes 52 of the plurality of coupling projections 24 constituting a plurality of bend center points of the wire guide 10. In this way, when the wire guide 10 is bent and deformed, a strain applied to the joined part of the pair of joining portions 48, 48 can be suppressed to a minimum level. Therefore, the peeling of the pair of joining portions 48, 48 can be advantageously prevented.

According to the flexible exterior member 12 of the present disclosure structured as described above, the opening continuous over the entire length in the axial direction of the tubular portion 34 can be provided by opening the slit 36 when the flexible exterior member 12 is sheathed on the wire guide 10. Therefore, as compared to a conventional structure, the wire guide 10 can be easily and quickly accommodated into the tubular portion 34 through the opening. Further, it is also possible to automate an operation of assembling the flexible exterior member 12 with the wire guide 10. Moreover, possible deformation of terminals provided on the tip of the wiring harness W can also be avoided when the wire guide 10 is inserted into the rubber boot in the conventional structure. In addition, the necessity of an operation of applying a lubricant or the like in the conventional structure can be reduced or eliminated.

Moreover, after the flexible exterior member 12 is sheathed on the wire guide 10, the opening formed by the slit 36 can be closed by joining the pair of joining portions 48, 48. Therefore, the detachment of the flexible exterior member 12 from the wire guide 10 can be hindered. Further, the dustproofness and waterproofness of the flexible exterior member 12 can be advantageously ensured. Furthermore, by providing the tubular portion 34 with the slit 36, the flexible exterior member 12 can be easily sheathed on the wire guide 10 without requiring the enlargement of the tubular portion 34. Therefore, a clearance between the flexible exterior member 12 and the wire guide 10 can be made as small as possible and the dustproofness and waterproofness of the flexible exterior member 12 can be further improved. Particularly, in this embodiment, the pair of joining portions 48, 48 are respectively provided to project outward in the right angle direction to the axis of the tubular portion 34 from the pair of circumferential end surfaces 50, 50 of the tubular portion 34. Thus, a space necessary for the joining operation of the pair of joining portions 48, 48 may be secured outside the tubular portion 34. In this way, the clearance between the flexible exterior member 12 and the wire guide 10 can be more advantageously reduced, and the dustproofness and waterproofness of the flexible exterior member 12 can be more stably ensured. In addition, since the pair of joining portions 48, 48 are put together and welded, the strength of the pair of joining portions 48, 48 where a stress easily concentrates during the deformation of the wire guide 10 can be advantageously ensured.

### Modifications

Although the embodiment has been described in detail as a specific example of the present disclosure, the present disclosure is not limited to this specific description. Modifications, improvements and the like within a range in which the aim of the present disclosure can be achieved are included in the present disclosure. For example, the following modifications of the embodiment are also included in the technical scope of the present disclosure.

(1) Although the pair of joining portions 48, 48 of the flexible exterior member 12 are joined using a welding technique such as thermal welding or ultrasonic welding in the above embodiment, these may be joined by a bonding technique using an adhesive or double-sided adhesive tape.

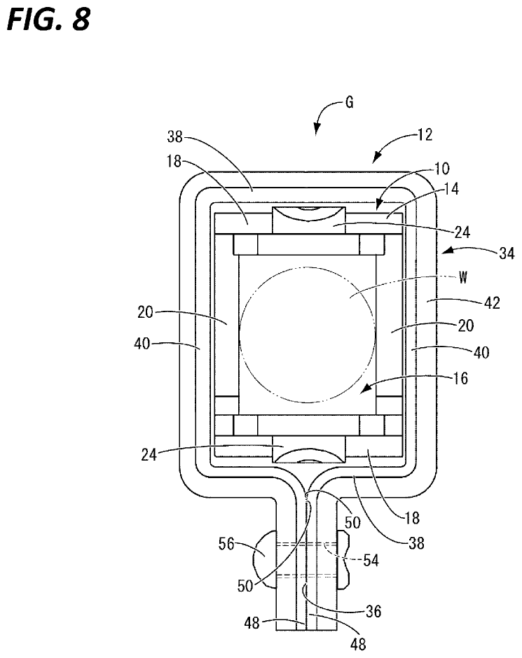

(2) The pair of joining portions 48, 48 of the flexible exterior member 12 may be joined by a mechanical method. For example, as shown in FIG. 8, rivet insertion holes 54 are provided at a plurality of positions separated in axial directions of the pair of joining portions 48, 48. The joining portions 48, 48 may be joined by inserting rivets 56 into the rivet insertion holes 54 and swaging the rivets 56 by a dedicated tool such as a rivet punch.

(3) Although the pair of joining portions 48, 48 are continuously provided over the entire length in the axial direction of the tubular portion 34 in the above embodiment, pairs of joining portions may be provided at a plurality of positions separated in the axial direction.

(4) Although the pair of joining portions 48, 48 are provided to project outward in the right angle direction from the pair of circumferential end surfaces 50, 50 in the above embodiment, there is no limitation to this. For example, a pair of joining portions may be provided to project in the circumferential direction from the pair of circumferential end surfaces 50, 50. In this case, the pair of joining portions can be advantageously joined by adhesion.

(5) Although the flexible exterior member 12 is formed using the olefin-based thermoplastic elastomer in the above embodiment, the flexible exterior member 12 can be formed using a rubber material such as ethylene propylene rubber (EPDM) or another elastomer material. The joining method of the pair of joining portions 48, 48 can be arbitrarily selected according to the material of the flexible exterior member 12.

### LIST OF REFERENCE NUMERALS

10 wire guide

12 flexible exterior member (flexible exterior member for wire guide)

14 link frame body

16 insertion space

18 first plate portion

20 second plate portion

22 coupling hole

24 coupling projection

26 body-side bracket

28 door-side bracket

30 fixing portion

32 locking projection

34 tubular portion

36 slit

38 first wall portion

40 second wall portion

42 bellows-like portion

44 large-diameter portion

46 small-diameter portion

48 joining portion

50 circumferential end surface

52 center axis (bend center point)

54 rivet insertion hole

56 rivet

B body

D slide door

G wire guide device

W wiring harness

1. A flexible exterior member for wire guide, comprising:
a hollow tubular portion to be sheathed on a wire guide bendable and deformable into a predetermined shape;
a slit provided over an entire length in an axial direction of the tubular portion; and
a pair of joining portions respectively provided on a pair of circumferential end surfaces of the tubular portion divided by the slit, the pair of joining portions being put together and joined to each other,
the pair of joining portions being provided to be arranged on a line connecting a plurality of bend center points of the wire guide.

2. The flexible exterior member for wire guide of claim 1, wherein the pair of joining portions are continuously provided over the entire length in the axial direction of the tubular portion.

3. The flexible exterior member for wire guide of claim 1, wherein the pair of joining portions respectively project outward in a right angle direction to an axis of the tubular portion from the pair of circumferential end surfaces of the tubular portion.

4. The flexible exterior member for wire guide of claim 1, wherein the tubular portion is in the form of a rectangular tube and the pair of joining portions are provided on a surface located on a lower side when the flexible exterior member is mounted in a vehicle, out of four surfaces of the tubular portion.

5. The flexible exterior member for wire guide of claim 1, wherein the pair of joining portions are in the form of flat plates having smooth surfaces.

6. (canceled)

7. The flexible exterior member for wire guide of claim 1, wherein the tubular portion includes a bellows-like portion formed by alternately connecting large-diameter portions and small-diameter portions in the axial direction.

8. The flexible exterior member for wire guide of claim 1, wherein the flexible exterior member is formed using a thermoplastic elastomer and the pair of joining portions are joined by being welded to each other.

9. A wire guide device, comprising:
a wire guide bendable and deformable into a predetermined shape; and
the flexible exterior member for wire guide of claim 1 sheathed on the wire guide.
